(19) United States
(12) Patent Application Publication
(10) Pub. No.: US 2012/0110460 A1
(43) Pub. Date: May 3, 2012

(54) Methods and Systems for Monitoring Network Performance

(76) Inventor: Russell David Wilson, Austin, TX (US)

(21) Appl. No.: 12/913,203

(22) Filed: Oct. 27, 2010

(51) Int. Cl. G06F 15/173; G06F 3/048

(52) U.S. Cl. 715/736

(57) ABSTRACT

Methods and systems for monitoring performance in electronic networks are provided. In some embodiments, a system may comprise a data collection server, a processor, and a user interface. The data collection server may be in electronic communication with a switch disposed in an electronic network. The processor may receive data collected by the data collection server from the switch. The processor may convert the data into a first format including a plurality of performance metrics. The user interface may be configured to display a matrix of data charts, each data chart including a trace of at least one of the plurality of performance metrics.

### TECHNICAL FIELD

The present disclosure generally relates to communication networks, and more specifically to methods and systems for monitoring network performance.

### BACKGROUND

Network managers and users often wish to monitor the performance of electronic networks, often to troubleshoot perceived performance lags and/or complaints. Typical goals of troubleshooting include identifying a problem, the cause of a problem, and/or the effect of a change in settings, equipment, and/or demand. One form of troubleshooting includes comparing a known performance (e.g., a baseline, a target, and/or a historical performance) against a current and/or identified performance.

### SUMMARY

The present disclosure provides techniques that substantially eliminates or reduces at least some of the disadvantages and problems associated with previous methods and systems. In some embodiments, a system may comprise a data collection server, a processor, and a user interface. The data collection server may be in electronic communication with a switch disposed in an electronic network. The processor may receive data collected by the data collection server from the switch. The processor may convert the data into a first format including a plurality of performance metrics. The user interface may be configured to display a matrix of data charts, each data chart including a trace of at least one of the plurality of performance metrics.

In other embodiments, an electronic network may comprise a plurality of nodes, a set of switches, a data collection server, a processor, and a user interface. The plurality of nodes may be in electronic communication through the set of switches. The data collection server may be in electronic communication with one of the set of switches. The processor may receive data collected by the data collection server from the one of the set of switches. The processor may convert the data into a first format including a plurality of performance metrics. The user interface may be configured to display a matrix of data charts, each data chart including a trace of at least one of the plurality of performance metrics.

In other embodiments, a non-transitory computer readable medium may store instructions for monitoring performance in an electronic network. The instructions, when executed by a processor, may be configured to: receive data from a switch associated with the electronic network; convert the data into a first format including a plurality of performance metrics; and display a matrix of data charts, each data chart including a trace of at least one of the plurality of performance metrics.

The teachings of the present disclosure, and systems and methods incorporating these teachings, may allow a network manager or another user to compare charts and/or graphs of multiple variables, both vertically and horizontally. A user may create a first vertical stacks of data traces of multiple variables and compare the first vertical data stack to a second similar data stack (e.g., a first stack associated with a first application and the second stack associated with a second application). The teachings of the present disclosure may allow a user to compare multiple time frames at the same time in addition to simultaneously comparing other variables. Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows an example electronic network system, in accordance with the teachings of the present disclosure;

FIG. 2 shows an example switching system including a switch configured to forward information between networks, nodes, and/or other switching entities, in accordance with the teachings of the present disclosure;

FIG. 3 shows an example user interface and other selected components of an example system for monitoring performance of an electronic network, in accordance with the teachings of the present disclosure; and

FIG. 4 shows an example of a user interface, in accordance with the teachings of the present disclosure.

### DETAILED DESCRIPTION

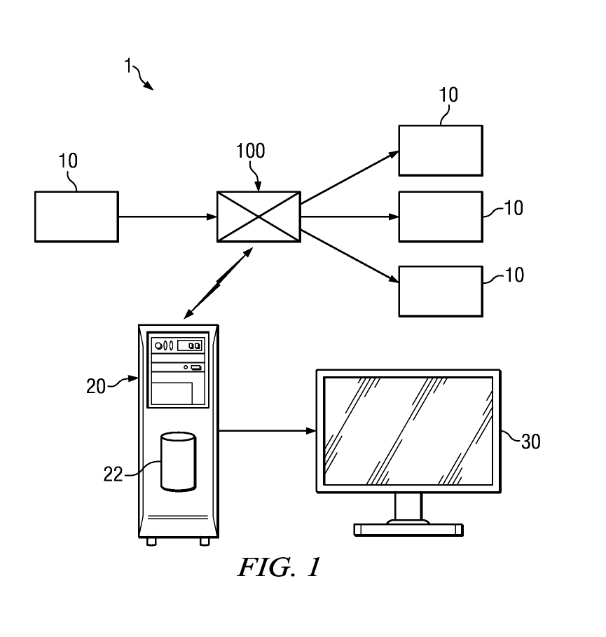

Preferred embodiments and their advantages are best understood by reference to FIGS. 1 through 4, wherein like numbers are used to indicate like and corresponding parts.

FIG. 1 shows an example electronic network system 1 including multiple nodes 10, a network analyzer 20, a display 30, and a switching system 100. Electrical network 1 may be a network and/or fabric configured to couple various nodes 10 to one another. In some examples, electrical network 1 may function to connect a host node 10 to a target node 10.

Electrical network 1 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data), or any combination thereof. Electrical network 1 may transmit data using wireless transmissions and/or wire-line transmissions via any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof. Electrical network 1 and its various components may be implemented using hardware, software, or any combination thereof.

Network analyzer 20 may include any component, device, and/or feature of electronic network 1 configured to measure one or more network parameters of electronic network 1. For example, network analyzer 20 may be used to analyze properties associated with the reflection and transmission of electrical signals known as scattering parameters (S-parameters). As another example, network analyzer 20 may analyze data passing through switching system 100 for use in monitoring and/or optimizing the performance of electronic network 1. Collecting, analyzing, and/or displaying one or more network parameters related to the performance of electronic network 1 may provide visibility into the composition and/or disposition of traffic on various links of electronic network 1. Use of the various network parameters may facilitate troubleshooting, identify the source of errors, validate actual and/or proposed changes, and/or allow reduced cost of operation.

Display 30 may include any component, device, and/or feature of electronic network 1 configured to display the data measured and/or collected by network analyzer 20. Display 30 may also be configured to display analysis performed by the network analyzer. For example, display 30 may include a computer monitor, a visual display unit, and/or other electronic components configured to display data and/or the result of analysis to a user. In some embodiments, display 30 may include a monitor configured to display a user interface designed to allow a user to access the various features and/or functions of network analyzer 20.

A switching system 100 may include one or more network switches and/or switching hubs connecting network segments. Use of a switching system may allow communication and/or connection between various nodes 10 without requiring direct connection between the nodes. In some electronic network systems, switching system 100 may be disposed in association with a particular node 10. The choice of node 10 may be related to a strategic and/or central location in relation to other nodes 10 of the network.

Switching system 100 may refer to a network bridge that processes and routes data between network segments. Many Ethernet local area networks (LAN) include multiple network switches. Use of network switches may allow various nodes on a LAN to exchange data without interfering with one another. In contrast, a network including a hub (e.g., a passive repeater) may share bandwidth for more than one data exchange at the same time. Switching system 100 may include unmanaged switches, managed switches, smart switches, enterprise managed switches, etc.

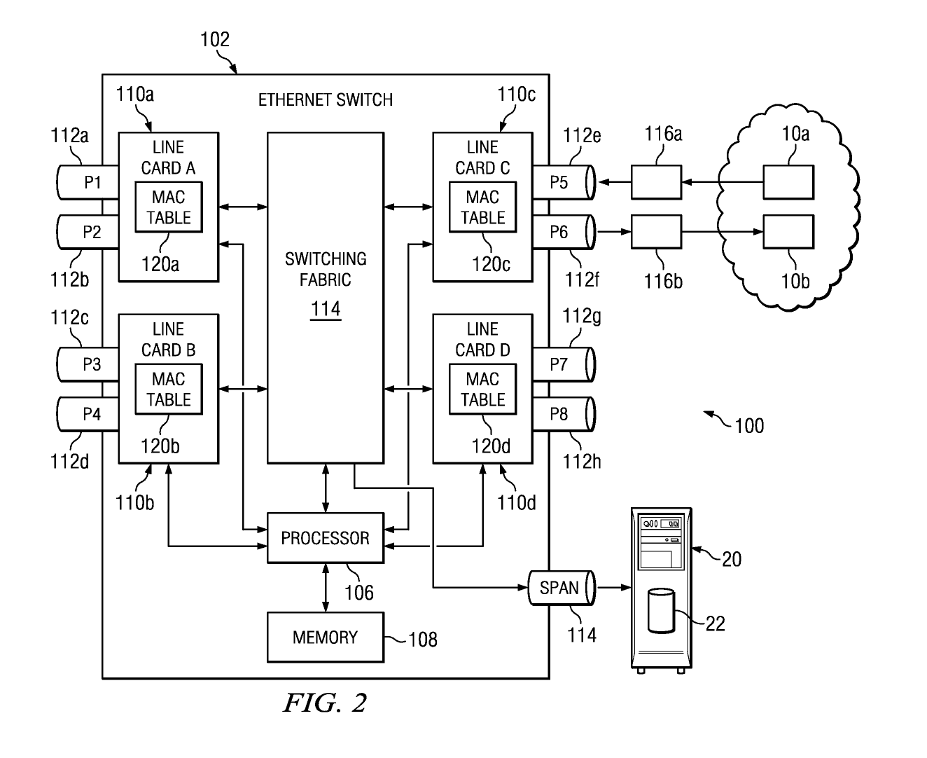

FIG. 2 shows an example switching system 100 including a switch 102 configured to forward information between networks, computing entities, and/or other switching entities. In one embodiment, switching system 100 may be configured to provide efficient space utilization of distributed MAC address tables. Switch 102 may include one or more ports 112, each port 112 communicatively coupled to one or more nodes 10 and/or additional network legs. Such coupling may use electronic network 1. Switch 102 may include one or more line cards 110, coupled to each other by way of a switching fabric 114.

Switch 102 may include a set of tables 120 associated with each line card 110. Tables 120 may include communication and forwarding information regarding network entities 104 connected to ports 112 for which addresses are known. As information, such as inbound frame 116a, is received into switch 102 by port 112, its destination may be looked up in table 120 to determine to which port 112 the information should be sent. Inbound frame 116a may be implemented in packets, frames, cells, and/or other received data to be forwarded. Information in tables 120 may be populated as information to be forwarded is received through ports 112. Switch 102 may include a processor 106 coupled to a memory 108. Processor 106 may be coupled to switching fabric 114 and line cards 110.

Switch 102 may be implemented in any suitable electronic device for carrying out the embodiments taught by the present disclosure. In one embodiment, switch 102 may be implemented as an Ethernet switch. In other embodiments, switch 102 may function as a router. Switch 102 may be configured to receive information to be forwarded to network destinations, and the information may be implemented in any form suitable for switch 102 to forward. In one embodiment, the information received may be implemented in an inbound frame 116a. Likewise, switch 102 may be configured to forward information in any suitable form. In some embodiments, information may be forwarded in the same form in which it was received. In one embodiment, the forwarded information may be implemented in an outbound frame 116b.

In some embodiments, switch 102 may include a port mirroring feature. Port mirroring may include sending a copy of one or more received frames to a network monitoring connection on a second port 114. Port mirroring may be referred to as a switched port analyzer (SPAN), a roving analysis port (RAP), switch monitoring (SMON), etc. In some switches with port mirroring, all data received by switch 102 may be copied and delivered to one or more destination ports 114.

Destination port 114 may sometimes be referred to as a destination span port, a monitor port, and/or as a span port. Destination port 114 may include any Ethernet physical port. Destination port 114 may monitor one, some, or all of the ports 112 associated with switch 102. Destination port 114 may be in communication with a network analyzer 10, providing electronic communication between network analyzer 10 and switch 102.

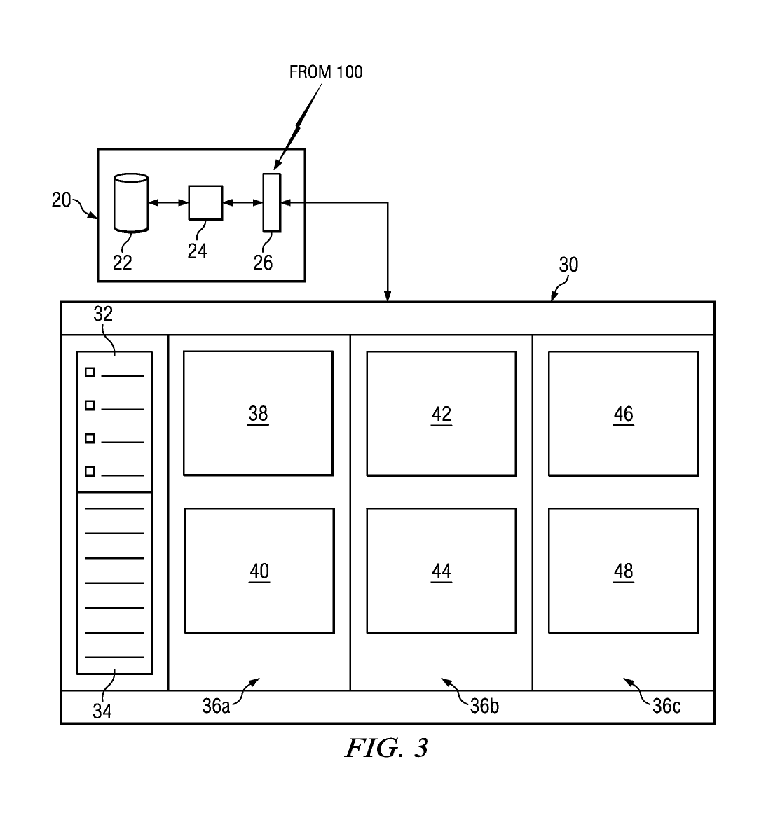

FIG. 3 shows selected components of an example system for monitoring the performance of electronic network 1. FIG. 3 shows network monitor 20 and display 30. As discussed in relation to FIG. 2, network monitor 20 may be receiving data from switching system 100 (e.g., from destination port 114).

Network analyzer 20 may comprise any suitable information handling system and may generally be operable to receive data from and/or communicate data to one or more other information handling systems. In certain embodiments, network analyzer 20 may include a server. In another embodiment, network analyzer 20 may include a personal computer. As depicted in FIG. 3, network analyzer 20 may include a processor 24, a memory 22 communicatively coupled to processor 24, a network interface 26 communicatively coupled to processor 24.

Memory 22 may be communicatively coupled to processor 24 and may comprise any system, device, or apparatus operable to retain program instructions or data for a period of time (e.g., computer-readable media). Memory 22 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to network analyzer 20 is turned off.

Processor 24 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 24 may interpret and/or execute program instructions and/or process data stored in memory 22 and/or another component of network analyzer 20.

Network interface 26 may be any suitable system, apparatus, or device operable to serve as an interface between network analyzer 20 and switching system 100 and/or other components and/or nodes 10 of electronic network 1. Network interface 26 may enable network analyzer 20 to communicate over electronic network 1 using any suitable transmission protocol and/or standard, including without limitation all transmission protocols and/or standards enumerated below with respect to the discussion of electronic network 1.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

Display 30 may include a user interface configured to convey information and/or data related to and/or associated with the performance of electronic network 1 and/or switching system 100. For example, display 30 may include a graphic user interface (GUI) configured for display on a computer monitor and/or television screen. Display 30 may include one or more features configured to facilitate the management of electronic network 1 based on the performance of electronic network 1.

For example, a complex electronic network may suffer from various performance complications and/or compromises. In some embodiments, a network manager may wish to troubleshoot a problem in electronic network 1. Troubleshooting may include a series of techniques employed in order to determine whether there is a problem, what is causing the problem, whether the problem is recurring, and/or various additional queries. In some examples, troubleshooting may include comparing the performance of electronic network 1 under a first set of conditions to the performance of electronic network 1 under a second set of conditions. Network analyzer 20 may compile data and/or analyze data related to the performance of electronic network 1 as described above and display the results using a GUI associated with display 30. In some embodiments, a user and/or network manager may compare data for a given time span and/or event to a baseline, an acceptable range, and/or a target set of data.

As shown in FIG. 3, one embodiment of a GUI may include multiple data traces 38-48 arrayed in a matrix. The GUI may also include a menu 32 of one or more pre-defined data sets, a list 34 of performance metrics, and/or multiple data stacks 36a-36c. Each element of the GUI may be selectively hidden and/or displayed as desired by the user. Use of the teachings of the present disclosure may provide increased flexibility for troubleshooting and/or comparison of the multiple data traces 38-48. Although FIG. 3 shows six respective data traces, any appropriate number may be included through the teachings of the present disclosure.

As shown in FIG. 3, a first set of data traces, 38 and 40, may be stacked vertically. The first stack 36a of data traces may be analyzed vertically by a user and/or network manager. For example, data trace 38 and data trace 40 may share the same elapsed time along the horizontal axis. In this example, stack 36a including data trace 38 and data trace 40 may represent data associated with a single network node 10, geographic location, and/or other common factor. A second stack 36b may provide similar data for a second network node 10. For example, first stack 36a may include data related to an United States segment of electric network 1 and second stack 36b may include data related to a Far East segment of electronic network 1. Display 30 may allow a user and/or network manager to add and/or remove stacks 36 for horizontal comparison. Each stack 36 may be adjusted and/or modified to change the elapsed timeframe, different contexts, and/or any other basis for which comparison might be useful.

In one embodiment, a user and/or network manager may consider “network roundtrip time” over various time span. For example, the user may display network roundtrip time from 4 p.m. to 5 p.m. today next to the same time span yesterday. In another example, the user may display network roundtrip time in two different geographic locations. In another example, the user may display network roundtrip time for two different internet sites and/or portals.

Menu 32 may provide one or more predetermined sets of performance metrics for inclusion in a stack 36. In one embodiment, menu 32 may include a list of quick references to the one or more predetermined sets of performance metrics. As one example, a first predetermined set of performance metrics may be identified as “server troubleshooting” and may include data traces corresponding to “server utilization” and “server response time.” A user and/or network manager may compare a first data stack 36a associated with server troubleshooting for the most recent 24 hours to a second data stack 36b associated with server troubleshooting for the same time span one week in the past and a third data stack 36c associated with server troubleshooting for the same time span two weeks in the past. Other examples of predetermined performance metrics sets may correspond to menu options such as component overview, server, application, and/or network. Menu 32 may be hidden or displayed by a user command.

Some of the predetermined sets of performance metrics may include performance metrics with a shared heuristic. For example, if data trace 38 and data trace 40 both reveal that the corresponding performance metrics have increased at the same time, experience has shown that a likely cause of the increase is a particular problem and/or failure. Teachings of the present disclosure may allow a user to design his or her own predetermined sets of performance metrics based on the user's experience and/or to use one or more predetermined sets of performance metrics provided with network analyzer 20 and/or display 30.

The list 34 of performance metrics may include various performance metrics chosen to support troubleshooting and/or performance monitoring. Examples of metrics may include, but are not limited to, total transaction time, response time composition average, server response time, data transfer time, retransmission delay, network round trip time, effective network roundtrip time, connection time, TCP/IP sessions (open, complete, expired, etc.), TCP/IP session requests, TCP/IP session times, data volume (e.g., in bytes, in packets), data rate (e.g., bits per second, packets per second), users, packet loss percentage, user throughput, etc.

Display 30 may allow a user and/or network manager to highlight a specific span of time within a data trace (e.g., 38). Display 30 may apply the chosen highlight to the corresponding span in one or more of the other data traces (e.g., vertically within stack 36a, horizontally to data trace 42 and 46, and/or to all data traces shown on display 30). In some embodiments, display 30 may zoom to the chosen span in one or more of the data traces. Display 30 may allow a user to superimpose one data trace onto another, and/or an entire stack 36 onto another. Display 30 may include various options to enhance usefulness. For example, menu 32, data stacks 36,

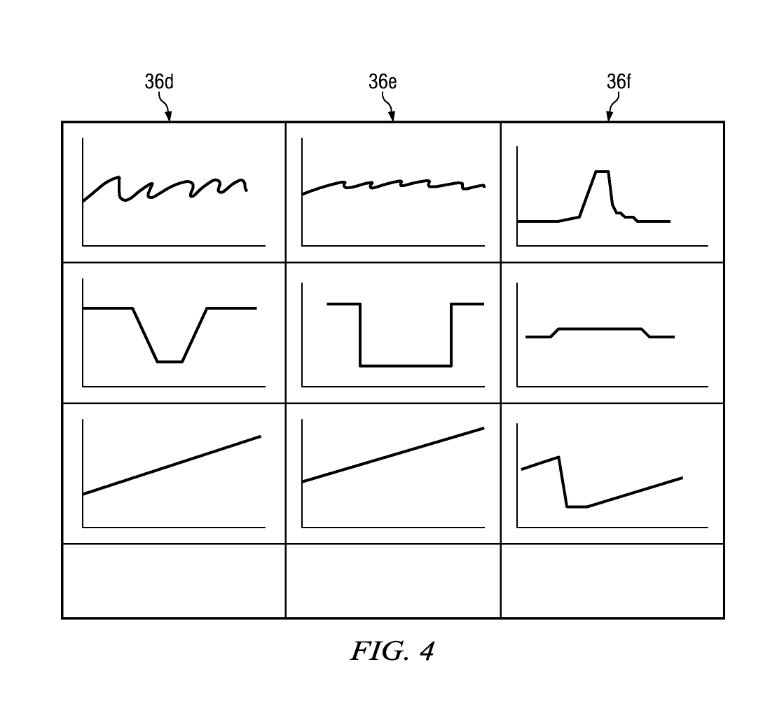

FIG. 4 shows another example display 30 including multiple stacks 36d-36f with various data traces therein. Although the figures and embodiments disclosed herein have been described, it should be understood that various changes, substitutions and alternations can be made herein without departing from the spirit and scope of the disclosure as illustrated by the following claims.

What is claimed:

1. A system for monitoring performance in electronic networks, the system comprising:
a data collection server in electronic communication with a switch disposed in an electronic network;
a processor receiving data collected by the data collection server from the switch;
the processor converting the data into a first format including a plurality of performance metrics; and
a user interface configured to display a matrix of data charts, each data chart including a trace of at least one of the plurality of performance metrics.

2. A system according to claim 1, further comprising the data collection server in communication with a destination port associated with the switch.

3. A system according to claim 1, further comprising:
a storage device in communication with the processor;
wherein the data collection server copies data from a destination port associated with the switch to the storage device.

4. A system according to claim 1, wherein the user interface comprises a graphic user interface.

5. A system according to claim 1, wherein the user interface comprises an internet browser.

6. A system according to claim 1, wherein the matrix includes at least two data stacks, each data stack comprising two or more data charts sharing a single elapsed time across their respective x-axes.

7. A system according to claim 1, further comprising the user interface displaying a menu configured to allow a user to select at least one predetermined set of performance metrics for display in the matrix of data charts.

8. A system according to claim 1, further comprising the matrix of data charts including a plurality of data stacks, each data stack including traces of at least two performance metrics having a heuristic relationship.

9. A system according to claim 1, further comprising the user interface allowing a user to superimpose a first data chart on top of a second data chart.

10. An electronic network comprising:
a plurality of nodes in electronic communication through a set of switches;
a data collection server in electronic communication with one of the set of switches;
a processor receiving data collected by the data collection server from the one of the set of switches;
the processor converting the data into a first format including a plurality of performance metrics; and
a user interface configured to display a matrix of data charts, each data chart including a trace of at least one of the plurality of performance metrics.

11. An electronic network according to claim 10, further comprising the data collection server in communication with a destination port associated with the switch.

12. An electronic network according to claim 10, further comprising:
a storage device in communication with the processor;
wherein the data collection server copies data from a destination port associated with the switch to the storage device.

13. An electronic network according to claim 10, wherein the user interface comprises a graphic user interface.

14. An electronic network according to claim 10, wherein the user interface comprises an internet browser.

15. An electronic network according to claim 10, wherein the matrix includes at least two data stacks, each data stack comprising two or more data charts sharing a single elapsed time across their respective x-axes.

16. An electronic network according to claim 10, further comprising the user interface displaying a menu configured to allow a user to select at least one predetermined set of performance metrics for display in the matrix of data charts.

17. An electronic network according to claim 10, further comprising the matrix of data charts including a plurality of data stacks, each data stack including traces of at least two performance metrics having a heuristic relationship.

18. An electronic network according to claim 10, further comprising the user interface allowing a user to superimpose a first data chart on top of a second data chart.

19. A non-transitory computer readable medium storing instructions for monitoring performance in an electronic network, the instructions, when executed by a processor, configured to:
receive data from a switch associated with the electronic network;
convert the data into a first format including a plurality of performance metrics; and
display a matrix of data charts, each data chart including a trace of at least one of the plurality of performance metrics.

20. A non-transitory computer readable medium according to claim 19, further comprising instructions configured to copy data from a destination port associated with the switch to the storage device.

21. A non-transitory computer readable medium according to claim 19, wherein the matrix includes at least two data stacks, each data stack comprising two or more data charts sharing a single elapsed time across their respective x-axes.

22. A non-transitory computer readable medium according to claim 19, further comprising instructions configured to display a menu configured to allow a user to select at least one predetermined set of performance metrics for display in the matrix of data charts.

23. A non-transitory computer readable medium according to claim 19, wherein the matrix of data charts includes a plurality of data stacks, each data stack including traces of at least two performance metrics having a heuristic relationship.

24. A non-transitory computer readable medium according to claim 19, further comprising instructions configured to allow a user to superimpose a first data chart on top of a second data chart.
